(19) United States
(12) Patent Application Publication
(10) Pub. No.: US 2008/0068641 A1
(43) Pub. Date: Mar. 20, 2008

(54) Document processing system

(75) Inventors: Christopher R. Dance, Meylan (FR); Jerome Pouyadou, Grenoble (FR); Francois Ragnet, Venon (FR); Florent C. Perronnin, Saint Martin d'Heres (FR)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/524,236

(22) Filed: Sep. 19, 2006

(51) Int. Cl. G06F 3/12

(52) U.S. Cl. 358/1.15

(57) ABSTRACT

A document processing method includes identifying a document which has been selected for printing that includes at least one image. For at least the one image of the identified document, assigning an image class to the image based on at least one feature extracted from the image. The document is assigned to a document category based on the assigned image class of the at least one image. A printing protocol is assigned to the document based on the assigned document category. In this way, personal documents can be identified and assigned a different printing protocol from documents which are more likely to be business-related documents.

### CROSS REFERENCE TO RELATED PATENTS AND APPLICATIONS

The following co-pending applications, the disclosures of which are incorporated herein by reference in their entireties, are mentioned:

U.S. patent application Ser. No. 11/418,949, filed May 5, 2006, entitled GENERIC VISUAL CLASSIFICATION WITH GRADIENT COMPONENTS-BASED DIMENSIONALITY ENHANCEMENT, by Florent Perronnin;

U.S. patent application Ser. No. 11/170,496, filed Jun. 30, 2005, entitled GENERIC VISUAL CATEGORIZATION METHOD AND SYSTEM, by Florent Perronnin.

U.S. patent application Ser. No. 11/XXX,XXX (Atty. Docket No. 20060463-US-NP), filed contemporaneously herewith, entitled BAGS OF VISUAL CONTEXT-DEPENDENT WORDS FOR GENERIC VISUAL CATEGORIZATION, by Florent Perronnin.

### BACKGROUND

The exemplary embodiment relates to printing of images. It finds particular application in connection with image characterization for identifying images, such as personal photographs, which are to be assigned a different printing protocol from other images. However, it is to be appreciated that the exemplary embodiment may find application in image classification, image content analysis, image archiving, image database management and searching, and the like.

Laser printing systems for office use are now available which are capable of rendering color images with image quality approaching or exceeding that of professional photographic printing services. Such printing systems allow businesses to print work-related documents containing color images, such as brochures, reports, maps, charts, marketing materials, photographs of business events, customer documents, and the like, on demand. However, the widespread availability of digital cameras, optical scanners, and other digital image sources, has led to the printing of large numbers of digital images for personal use, such as personal photographs and documents containing such images. Unauthorized printing of non-business images by employees results in additional costs to businesses that own or rent such printing systems. Blocking the printing of all image-containing documents would prove unsatisfactory to most businesses. As a result, businesses may opt to make available only monochrome (black and white) printing systems to their employees.

### BRIEF DESCRIPTION

In one aspect of the exemplary embodiment disclosed herein, a document processing method includes identifying a document selected for printing that includes at least one image. For at least one image of the identified document, an image class is assigned to the image based on at least one feature extracted from the image. The document is assigned to a document category based on the assigned image class of the at least one image. A printing protocol is assigned to the document based on the assigned document category.

In another aspect, a system for document processing includes a print driver comprising processing components which: identify documents, selected for printing by a user, that include images, assign an image class to at least one image in an identified document, based on at least one feature extracted from the image, assign the document to a document category based on the assigned image class of the at least one image, and assign a printing protocol to the document based on the assigned document category. At least one printer is in communication with the print driver for rendering documents in accordance with the assigned printing protocol.

In another aspect, a method for monitoring or restricting printing of personal documents which include color images on a color printer includes classifying documents which include color images with an automated classifier which is trained to discriminate between business documents comprising business images and personal documents comprising personal images, based on image content. A first printing protocol is assigned to a first document which is classified as a business document, the first printing protocol permitting printing of the first document on the color printer. A second printing protocol is assigned to a second document which is classified as a personal document, the second printing protocol including at least one of monitoring and restricting printing of personal documents on the color printer. The assigned printing protocols are executed.

### BRIEF DESCRIPTION OF THE DRAWINGS

FIG. 1 is a functional block diagram of an image processing system according to the exemplary embodiment; and

FIG. 2 is a flow diagram of an image processing method according to the exemplary embodiment.

### DETAILED DESCRIPTION

Aspects of the exemplary embodiment disclosed herein relate to a document processing method and to a system for processing documents. The exemplary method includes identifying a document to be printed that includes one or more images. For each image of the document, the method includes classifying the image based on the image content, for example, by identifying features in regions of interest within the image and assigning the image to one or more classes based on the identified features. Based on the classification of the image, and the classification of any other images in the document, the document as a whole is categorized and assigned a printing protocol selected from a plurality of protocols based on the categorization. The selected protocol may be implemented automatically. The exemplary method enables non work-related (“personal”) documents containing images to be treated in a different manner to work-related (“business”) documents containing images. For example, color printing of image-containing documents classified as personal may be denied in whole or in part, or the printing tracked for accounting, notification, or other purposes.

The exemplary image processing system may include a processing component, such as a print driver, which executes the exemplary method, a control system which implements the selected protocol, and a printer.

Some of the benefits which may be accrued with such a system include enabling office workers to print personal photos within a trusting automated accounting environment and enabling companies to reap the full benefits of color printing without incurring the cost of personal photo printing.

As used herein, a “printer” can include any device for rendering a document on print media, such as a copier, laser printer, bookmaking machine, facsimile machine, or a multifunction machine. “Print media” can be a usually flimsy physical sheet of paper, plastic, or other suitable physical print media substrate for rendering the document. A “print job” or “document” is normally a set of related original print job sheets or electronic document pages, from a particular user, or otherwise related, although in some instances, a document may comprise a single image. Documents to be rendered on the print media by the printer may include digital information comprising images and/or text. The operation of applying images and/or text to print media is generally referred to herein as printing or marking.

An image, as used herein, generally may include two-dimensional information in electronic form which is to be rendered and may include graphics, photographs, and the like. Images may include JPEG, GIF, BMP, TIFF, PDF, or other image formats. “Color images” are generally those images with image data expressed in two or more color dimensions which can be rendered with two or more colorants, such as inks or toners by a color printer. Color images may also include monochrome images which, because of the particular color, cannot be rendered on a black and white printer. As used herein, “text” refers to the non-image content of documents and generally comprises characters formatted in Microsoft Word or similar text format.

“Business documents” are generally work-related documents and may include pages containing color images, such as maps, charts, real estate designs, insurance evidence, team photos, marketing or advertising collaterals, internet faxes, camera images of documents, and the like, which a business would normally consider printing in pursuit of its business objectives. “Personal documents” can be considered as encompassing all documents which are not business documents and generally are non work-related documents. What constitutes a business document may depend, in part, on the nature of the business operating the image processing system. For example legitimate business documents for a travel company may include photographs of beach scenes, while for a tool manufacturing company, such documents are more likely to be categorized as personal documents.

What constitutes a business image or business document containing such an image may be designated by an IT manager or other employee who sets the controls of a print infrastructure management system. The IT manager may select a set of image categories that are to be subject to a selected printing protocol. For example, the IT manager selects which categories are notified for, accounted for, blocked, or always allowed. Exemplary business categories that may be selected for a protocol which allows printing may include maps, charts, graphs, engineering drawings, company logos, real estate designs, insurance evidence, team photographs, ID pictures, marketing or advertising collaterals, internet faxes, medical and biological images, conferences, trade shows, working groups, electronic products and devices, camera images of documents, depending on the nature of the business. Personal image categories which may be assigned notification, accounting, or blocking protocols may include beaches, landscapes, sports, boating, parties, babies and children, animals, buildings, theater shows, concerts, weddings, and other categories containing predominantly personal images.

The exemplary image processing method may be implemented as instructions in a computer program product that may be executed on a computing device. The computer program product may be a tangible computer-readable recording medium on which a control program is recorded, or may be a transmittable carrier wave in which the control program is embodied as a data signal. The computer readable medium can comprise an optical or magnetic disk, magnetic cassette, flash memory card, digital video disk, random access memory (RAM), read-only memory (ROM), combination thereof, or the like for storing the program code.

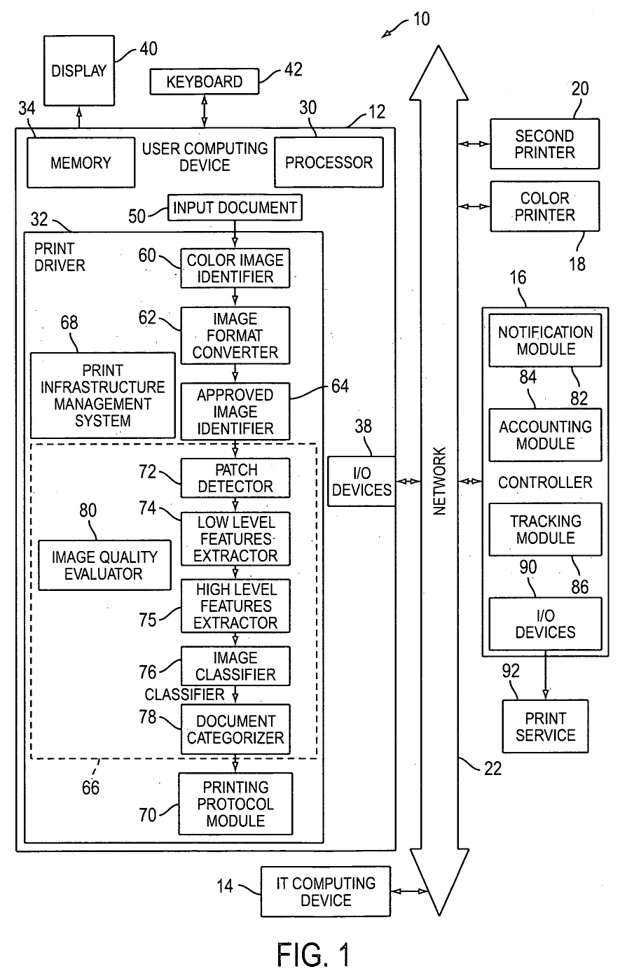

With reference to FIG. 1, a functional block diagram of an image processing system 10 is shown. The system 10 is capable of receiving documents to be printed, categorizing image-containing documents, and implementing a printing protocol based on the categorization. The illustrated system 10 includes one or more computing devices 12, 14, a controller 16, and one or more printers 18, 20, such as a color printer 18 and a monochrome or second printer 20, all linked (e.g., wired or wirelessly) by a common network 22, such as a local area network (LAN) or wide area network (WAN), or the Internet. The controller 16 may reside on a network server, on a printer 18, one of the computing devices 14, or elsewhere in the network 22 or in communication therewith.

Each of the computing devices 12, 14 may be in the form of a conventional general purpose personal computer or the like. In the illustrated embodiment, one of the computing devices 12 is designated as a user computing device and another device 14 is designated an information technology (IT) computing device, which is accessed by an IT representative authorized to monitor and/or modify the system 10. It will be appreciated that the system 10 may include additional user devices 12 and that the IT device 14 may be similarly configured to the user device 12. The computing device 12 may be a PC, such as a desktop, a laptop, palmtop computer, portable digital assistant (PDA), cellular telephone, pager, or other digital device with capability for processing images and outputting the images to a printer.

Each of the computing devices may include a processor 30, a print driver 32, a system memory 34, and one or more input/output (I/O) interfaces 38 that couple the computing device components to other devices via the network 22, such as a modulator/demodulator (MODEM). Additional I/O devices (not shown) couple the computing device 12 to an associated display 40, such as a color monitor, and user interface 42, such as a keyboard, cursor control device, touch screen, or the like for inputting text and for communicating user input information and command selections to the processor 30. The components of the computing 12 device may all be coupled by a system bus (not shown).

The memory 34 may represent any type of computer readable medium such as random access memory (RAM), read only memory (ROM), magnetic disk or tape, optical disk, flash memory, or holographic memory. In one embodiment, the memory 34 comprises a combination of random access memory and read only memory. In some embodiments, the processor 32 and memory 34, and optionally also the print driver 32, may be combined in a single chip.

As will be appreciated, FIG. 1 is a high level functional block diagram of only a portion of the components which are incorporated into the system 10. Since the configuration and operation of programmable computers and network systems are well known, they will not be described in particular detail.

The print driver 32 may be configured as for a conventional print driver except as noted. As with a conventional print driver, the illustrated print driver receives input documents 50, converts the documents to a printer-ready format, and outputs the documents to a printer 18, 20. In general, the print driver 32 is capable of distinguishing images from text in the documents to be printed and is capable of separating the electronic information constituting each image for further processing.

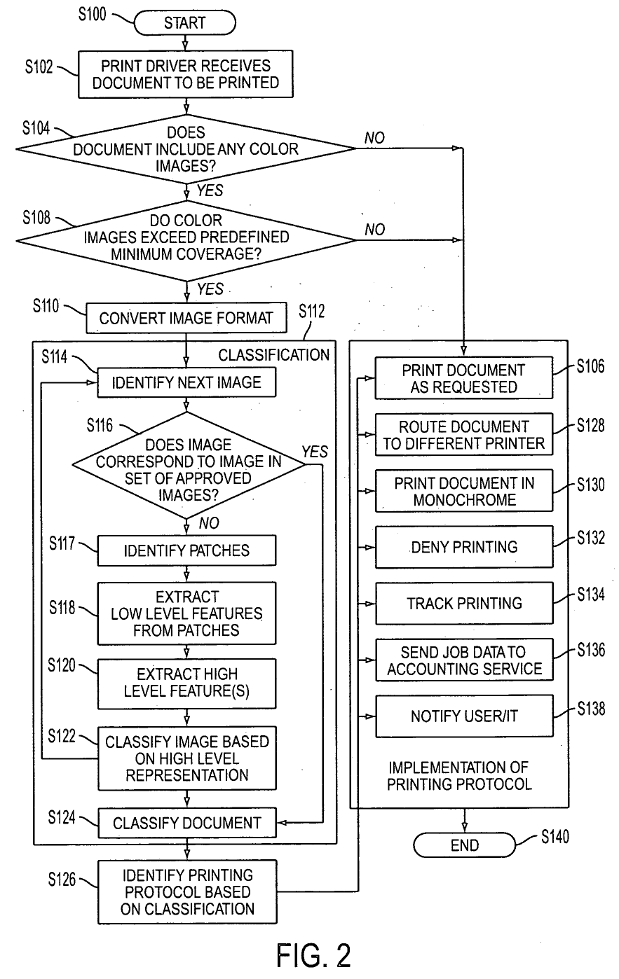

The illustrated print driver 32 may also include processing components for classifying image-containing documents and assigning a print protocol thereto, namely a color image identifier 60, an image format converter 62, an approved image identifier 64, a classifier 66, a print infrastructure management system 68, and a printing protocol module 70, which may all be connected by a system bus (not shown). While the illustrated processing components 60, 62, 64, 66, 68, 70 are illustrated as being functionally within the print driver 32 on the user's computer 12, it is contemplated that some or all of these components may be located elsewhere in the system 10, such as on the print controller of the printer 18, 20 or on a print server (i.e., an external component of the network 22 to which print requests are routed), or distributed among several network components. Accordingly, where reference is made to the print driver 32, it is to be assumed that such other locations are also contemplated. The functions of the processing components 60, 62, 64, 66, 68, 70 are described more particularly with reference to the method illustrated in FIG. 2.

The color image identifier 60 detects image content, in particular, print jobs that contain only images, or have only a small amount of text. In general, printing of black and white (monochrome) personal images is less of a concern to the business owner than is printing of personal color images, due to the differential cost of color printing. Accordingly, where the document file header selects a black only printer or selects black printing on a combined color and black printer, the document may be sent for printing without determining image content.

The image format converter 62 optionally converts the image to a suitable common format for processing by the classifier 66.

Optionally, the approved image identifier 64 identifies images/documents which are approved for printing. The color image identifier 60 and approved image identifier 64, where present, provide a first filter. Documents can be filtered out by the first filter for processing by the classifier 66. Other documents may proceed to printing if the image content is determined to be below a predetermined threshold and/or the image/document is an approved document.

The classifier 66 includes components for identifying features within the images. Based on the identified features, the classifier classifies the image into one of a plurality of categories from which a categorization of the document as a whole can be derived. The illustrated classifier includes a patch detector 72, one or more feature extractors, herein illustrated as a low level feature extractor 74 and a high level feature extractor 75, an image classifier 76, a document categorizer 78, some or all of which may be trained on a set of training images, as described in above-mentioned application Ser. Nos. 11/418,949 and 11/170,496, incorporated herein by reference.

The patch detector 72 identifies regions of interest (patches) of an image which are likely sources of features. The patch detector 72 may be omitted if, for example, the patches are selected based on a grid.

The low-level feature extractor 74 extracts low-level information (features) from the patches of the image identified by the patch detector 72. Examples of such low-level information may include texture, shape, color, and the like. The high-level feature extractor 75 transforms a set of local low-level features into a high level representation comprising one (or more) global high-level feature(s) which characterizes the content of the image as a whole.

The image classifier 76 then assigns an image class to the image based on the computed high-level feature. For example, the image of a child with a cat may be classified as an “image containing child or animal,” if the high-level feature contains information about cat and child body parts. The output of the image classifier 76 may be an assignment of each image in the document to an image class selected from a set of image classes. Of course, rather than descriptive classes, such as, landscape, beach, animal, child, business attire, chart, graph, etc. the classifier may simply assign each image to a more generic class, such as a “personal” class or a “business” class. For some images, where features or a class cannot be identified by the classifier with confidence, an “unknown” class may be assigned.

The document categorizer 78 classifies the document into one of a plurality of document categories as a function of the assigned image classes of the images in the document. For example, there may be at least two categories such as “business document” and “personal document”. Personal documents may include those with one or more images classed as beaches, sports, boating, parties, babies and children, weddings and the like.

The training images used for training the classifier 66 are generally selected to be representative of image content classes that the trained classifier is intended to recognize. In accordance with the method described in above-mentioned application Ser. No. 11/170,496, patches within the training images are clustered automatically to obtain a vocabulary of visual words. In some approaches, the visual words are obtained using K-means clustering. In other approaches, a probabilistic framework is employed and it is assumed that there exists an underlying generative model such as a Gaussian Mixture Model (GMM). In this case, the visual vocabulary is estimated using the Expectation-Maximization (EM) algorithm. In either case, each visual word corresponds to a grouping of low-level features. In one approach, an image can be characterized by the number of occurrences of each visual word. This high-level histogram representation is obtained by assigning each low-level feature vector to one visual word or to multiple visual words in a probabilistic manner. In other approaches, an image can be characterized by a gradient representation in accordance with the above-mentioned application Ser. No. 11/418,949.

Each training image of the set of training images is also suitably labeled, annotated, or otherwise associated with a manually assigned image class which describes the image more globally than the feature descriptors. The image classifier 76 may thus be trained to associate a set of feature descriptors with an image class (optionally with a confidence weighting). The image class may be identified by a verbal descriptor (“image containing child or animal,” “landscape,” “beach scene,” “wedding,” “sporting event,” “image containing company logo,” “business attire image-lacking children and animals,” and the like), or a unique code which represents the image class. The training image descriptors along with their high-level representations are used as input for training the image classifiers. In one approach, there is one such classifier per class. Typically, a decision boundary between the positive and negative samples (i.e. between the images that belong to the considered class and the others) is estimated. In one approach, this decision boundary may be a hyper-plane computed with the logistic regression algorithm.

As will be appreciated, the classifier 66 may incorrectly assign features or assign image classes in some instances, resulting, for example, in a document which would be considered a probable business document by the IT manager to be assigned to a different category.

The classifier 66 may incorporate other components which are used to provide information for assigning the document category. For example, an image quality evaluator 80 may evaluate the image quality (size of image file, resolution, blurring, contrast, and the like). Relatively poor quality images are more likely to be consumer photos than business documents.

The printing protocol module 70 assigns a printing protocol to the document, based on the document classification by the classifier and optionally also on other factors, such as the user's status. The printing protocol may be selected from a plurality of protocols, such as those which always allow printing or restrict or monitor printing in some way.

The print infrastructure management system 68 includes the sets of features, image descriptors, and protocols, which may be updated by the IT department or automatically, in response to changes in user's image printing habits, feedback from users, changes in company documents or logos, or other factors.

Instructions to be executed by the various processing components 60, 62, 64, 66, 68, 70 of the print driver may be stored in the main memory 34 or in a separate memory associated with the print driver.

The control system 16 implements the print protocol selected by the print driver. The illustrated control system 16 includes a plurality of modules, such as a notification module 82, an accounting module 84, and/or a tracking module 86. The notification module 82 sends a notification to the IT computing device 14, when specified by the printing protocol. The accounting module 84 sends print job information, such as number of pages printed and user name, to an account file, which can be used for billing jobs designated personal to the user. The tracking module 86 may track print job usage by user, and communicate usage above a monthly threshold to the notification module. The controller 16 may also include one or more output devices 90 for communication with the printers and with an external print service 92, e.g., via the internet.

With reference to FIG. 2 a flow diagram illustrates an exemplary image processing method which may be performed using an image processing system such as the system 10 illustrated in FIG. 1. It is to be appreciated that the method may include fewer, more, or different steps than those illustrated and that the steps need not proceed in the order specified.

Prior to performing the method, an IT manager sets the controls of the print infrastructure management system. These include a set of image categories that are to be notified for, accounted for, blocked or always allowed.

The method begins at step S100. At step S102, the print driver receives a document which has been selected by a user for printing. For example, the user views a document on the screen and selects print. The processor creates a print file which is sent to the print driver. The print driver collects the data to be sent out to the printer. This data collection can actually take place at several places, depending on IT configuration and hardware capabilities of the system, for example in one of the elements of the print system on the user's computer (i.e. within the actual driver itself, on the print controller (i.e. in the printer itself), on a print server (i.e. an external system to which print requests are routed).

At step S104, the document is evaluated by the color image identifier for image content. In general, this is achieved without the need for a full PostScript interpreter as certain binary information patterns only occur in images. For XPS (XML Paper Specification), an XML-based document exchange format, this is even easier, as the document file contains direct links to JPEG files. For example, the page description language (PDL), i.e. the language understood by the printer, is searched for potential images. If the PDL is PostScript, the color image identifier searches for image drawing operators. If the PDL is XPS, the image files embedded directly within the XPS flux are located. If the document has no color image content (e.g., contains no color images) or is designated for black only printing, the document is sent for printing (step S106) without further analysis.

If at step S104 the document is determined to have color image content, the color content is determined (step S108). This is readily accomplished in PostScript by computing an image-to-text area ratio. For example, if the document exceeds a predetermined ratio of image: text, it is classed as an image-containing document.

If at step S108, the determined image coverage of the document exceeds a predetermined threshold, and is not automatically approved for printing, at step S110, the images in the document may be converted to a suitable format for analysis by the classifier 66.

At step S112; the document is classified based on the image content. Step S112 may include the substeps S114, S116, S117, S118, S120, and S122. At step S114, the classifier identifies each image in sequence and proceeds through steps S116, S117, S118, S120, and S122. At step S116, the image may be compared with a set of approved images. For example, the file header of the image is compared with a set of file headers for approved images. If the image is among those approved as business images, or has been otherwise tagged as an approved image, e.g., by the IT representative, steps S117, S118, and S120 may be omitted and the image automatically classified as a business image at step S120. If at step S116, the image is not recognized as an approved business image, the method proceeds to step S117.

At step S117, the patch identifier 72 identifies patches (subsamples) of the image for analysis. In one embodiment a Harris affine detector technique is used for identification of patches (as described by Mikolajczyk and Schmid, “An Affine Invariant Interest Point Detector ECCV, 2002, and “A Performance Evaluation Of Local Descriptors,” in IEEE Conference on Computer vision and Pattern Recognition (June 2003). Alternatively, features can be extracted on a regular grid, or at random points within the image, or so forth, avoiding the need for patch identification.

At step S118, any distinguishable features are extracted, e.g., by comparing the patch information with stored feature information using the methods as described, for example, in application Ser. Nos. 11/418,949 and 11/170,496, discussed above. For example, the low level feature extractor 74 generates a features vector or other features-based representation of each patch in the image. Image features are typically quantitative values that summarize or characterize, for the patch region, aspects of the image data within the region, such as spatial frequency content, an average intensity, color characteristics, and/or other characteristic values. In some embodiments, about fifty features are extracted from each patch. However, the number of features that can be extracted is not limited to any particular number or type of features. In some embodiments, Scale Invariant Feature Transform (SIFT) descriptors (as described by Lowe, “Object Recognition From Local Scale-Invariant Features,” ICCV (International Conference on Computer Vision), 1999) are computed on each patch region. SIFT descriptors are multi-image representations of an image neighborhood, such as Gaussian derivatives computed at, for example, eight orientation planes over a four-by-four grid of spatial locations, giving a 128-dimensional vector (that is, 128 features per features vector in these embodiments). Other feature extraction algorithms may be employed to extract features from the patches. Examples of some other suitable descriptors are set forth by K. Mikolajczyk and C. Schmid, in “A Performance Evaluation of Local Descriptors,” Proceedings of the Conference on Computer Vision and Pattern Recognition (CVPR), Madison, Wis., USA, June 2003.

Once the low-level feature vectors or other representations have been derived, they are used to form a high-level representation (S120).

At step S122, the image is classified based on the high-level representation using the trained classifiers. Typically, a score is obtained whose value depends on which side of the decision boundary the high-level representation falls and on the distance to the decision boundary. If the score exceeds a threshold value, a match is assumed and the image is assigned to that image class. Alternatively, the image class which generates the highest computed score is selected.

Once all the images in the document have been classified (or a selection thereof, for large documents), the method proceeds to step S124, where the document as a whole is categorized, based on the assigned classifications of the images. The document categorization may be a function of all the image classes assigned to the document or may be based on fewer than all images in the document, or even based on a single image. For example, any document which includes an image designated “image containing company logo” may automatically be assigned to the “business document” category. In this way, the classifier may be conservatively weighted in favor of printing.

In one embodiment, the categorization may be a weighting which is representative of a determined likelihood of the document being a business document. As an example, a document which includes multiple images that have been assigned an image descriptor corresponding to “person in business attire” may be assigned a 90% likelihood of being a business document, while a document containing one such image and multiple images with the image descriptor “beach” may be designated a 10% likelihood of being a business document. A triggering factor may be selected, such as 50%, 60%, or 70% at which a document is classified as a business document.

The classification of the document may also depend on other factors, such as the quality of the image, as determined by the image quality evaluator 80, with a higher business document weighting being applied to documents comprising higher resolution images. The weighting may also take into account the environment in which the document is printed. For example, surges in the number of images of a certain print quality submitted by a particular user for printing may signify that the images are more likely to be private documents. In such cases, the weighting of the documents may be assigned a greater likelihood of being private than they would otherwise (or the triggering factor lowered). To allow surges in printing to be taken into account, statistics may be kept on an ongoing basis of a user's image printing, and those of other users, such as average number of images per printed document, average image quality and such, per user and/or group of users. If values above the average were to be detected (a repeated number of high quality pictures printed in a short amount of time, for example), this could be used as an indicator, in addition or in conjunction with the normal results of the categorization process, that the probability that the job contains personal pictures should be slightly boosted within the request analysis process, or by lowering the triggering factor slightly. Similarly, images which have been printed by multiple other users are more likely to be business images and thus the weighting of an image or the document containing such an image may be adjusted in favor of a business document classification.

At step S126, a printing protocol is assigned to the print job based on its document category. Documents classified as business documents at step S124 may be assigned a protocol which allows printing, such as “permit printing as requested by user.” Personal documents may be assigned a protocol such as “notify user before printing,” “deny printing,” “notify IT department,” “notify accounting,” “track usage,” “redirect print job to another printer,” “send document to outside print service,” or a combination of such protocols (e.g., “notify user and if user accepts, print document and notify accounting”).

The assigned printing protocol may depend on factors other than the assigned document category. For example, the protocol assigned may also depend, at least in part, on the status of the user (as identified by the log in name) and/or the extent of personal printing which the user is permitted. Some employees may be permitted to print a certain number of documents categorized as personal per month. For some users, the assigned protocol may be to favor printing unless the document is assigned a very high probability of being personal. For some users, the IT department may be notified for any document designated personal, while for others, the IT department may be notified only when personal document printing exceeds a preselected monthly threshold of printing. The protocol assigned may also depend on the extent of printing of the same document by other employees, which may be indicative that the document is a business document.

The assigned printing protocol may then be implemented. Depending on the assigned protocol, the implementation step may include one or more of printing the document as requested (step S106), routing the document to another printer (step S128), printing the document in monochrome (step S130), denying printing (step S132), tracking printing by user (step S134), sending print job data to an accounting service (step S136), and notifying the user and/or IT representative (step S138).

“The “redirect print job” protocol may be implemented by redirecting a print job designated “personal” to a non-conspicuous printer when a user has selected a color printer in conspicuous location, such as a front office where printing may be observed by customers. Alternatively, the “redirect print job” protocol may be implemented by redirecting color print jobs designated “personal” to a printer with a lower per page printing cost, such as monochrome printer 20. Where the protocol specifies sending the print job to another printer, at step S128 the user may be notified of the redirection. The user may decide to cancel the print job.

A “user notification” protocol may be implemented by warning the user, for example by printing a special warning page along with the document, or by sending out an email reminding the user of the company rules regarding usage of printers. A “tracking” protocol may be implemented by logging of the printing occurrence via IT-configurable logging channels, for example to assess the overall cost of personal printing requests. An “accounting” protocol may include logging the print job and the user's ID (e.g., by log in name), for billing the job to the user.

Two or more of the implementation steps may proceed sequentially, optionally with provision for user input. For example, if the protocol specifies “block printing and “notify user the printing may be blocked, at least temporarily, and the user notified, for example, by displaying a message on the user's screen. Depending on the protocol, the user may select another form of printing, such as monochrome, or opt to bill the job to a personal account. Or, the protocol may permit the user to notify the IT representative, requesting that document printing be permitted (“these are the images of the company picnic the boss asked to be printed”). The user may be notified automatically when printing has been approved so that the rendered print job can be collected from the printer.

The classification and assignment of a print protocol may proceed automatically, without user input or even of the user being aware that the steps are taking place. Implementation steps may also proceed automatically, other than where a user makes a selection in response to a prompt by the system.

In some systems, a user may be permitted to enter a billing code when selecting to print a document. For example, the user may select to bill to personal or bill to a specified client. In such instances, the document may be sent automatically for printing without classification.

Periodically, the IT representative may reconfigure the feature categories or image categories, or tag certain images as approved for printing, in response to user requests or system notifications, whereby the image is ultimately classified as personal or professional.

While the exemplary embodiment is described in terms of rendering a print job on print media, it is also contemplated that the document may alternatively be rendered in digital media, for example copying to disk or tape, or displayed on a screen.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A document processing method comprising:
identifying a document, selected for printing, that includes at least one image;
for at least the one image of the identified document, assigning an image class to the image based on at least one feature extracted from the image;
assigning a document category to the document based on the assigned image class of the at least one image; and
assigning a printing protocol to the document based on the assigned document category.

2. The method of claim 1, further comprising:
implementing the assigned printing protocol.

3. The method of claim 1, wherein the assigned printing protocol is selected from a predefined set of printing protocols.

4. The method of claim 3, wherein the document category is selected from a set of document categories, each of the document categories in the set being associated with one of the printing protocols.

5. The method of claim 4, wherein at least one of the document categories is associated with a printing protocol which comprises permitting printing of the document.

6. The method of claim 3, wherein the set of printing protocols include at least one printing protocol selected from the group consisting of:
blocking printing;
redirecting the printing of the document to a printer different from a printer selected for the printing;
storing information related to at least one of:
the document selected for printing,
the assigned document category, and
the identity of the user.

7. The method of claim 6, wherein when the assigned printing protocol includes storing information, the method further includes at least one of:
billing the user for printing of the document; and
determining whether the user has exceeded a quota for printing documents of the assigned category.

8. The method of claim 3, wherein the set of printing protocols include at least one printing protocol which permits printing of documents assigned to a first category and another printing protocol which restricts or monitors printing of documents assigned to a second category.

9. The method of claim 1, wherein the assigning of the printing protocol further includes identifying a status of the user, the assigning of the printing protocol being based on the assigned document category and the status of the user.

10. The method of claim 1, wherein when the document category relates to business documents, a first printing protocol is assigned, and when document category is more related to personal documents, a second printing protocol is assigned which differs from the first printing protocol.

11. The method of claim 1, wherein the identifying of the document includes at least one of
determining whether a document selected for printing includes at least one color image; and
determining whether the document selected for printing exceeds a preselected ratio of image: text.

12. The method of claim 1, wherein the assigning an image class to the image includes, for each of a plurality of regions within the image, assigning a feature descriptor based on characteristics of image data in the region; and
assigning an image class to the image based on the assigned feature descriptors.

13. The method of claim 12, wherein the assigning of a feature descriptor includes computing a features vector for the region of interest and comparing the features vector with a model derived from a set of training images, the model being associated in memory with a set of feature descriptors.

14. The method of claim 1, wherein the identifying a document that includes at least one image further comprises identifying a ratio of image to text for the document.

15. A system for document processing comprising a print driver which executes the method of claim 1.

16. The system of claim 15, wherein the system further includes a controller which implements the assigned printing protocol and at least one printer for printing the document when the assigned printing protocol permits printing of the document.

17. A computer readable medium comprising instructions for performing the method of claim 1.

18. A system for document processing comprising:
a print driver comprising processing components which:
identify documents, selected for printing by a user, that include images,
assign an image class to at least one image in an identified document, based on at least one feature extracted from the image;
assign the document to a document category based on the assigned image class of the at least one image, and
assign a printing protocol to the document based on the assigned document category, and
at least printer in communication with the print driver for printing documents in accordance with the assigned printing protocol.

19. The system of claim 18, wherein the processing component which assigns the image class is trained on a set of training images.

20. A method for monitoring or restricting printing of personal documents which include color images on a color printer comprising:
classifying documents which include color images with an automated classifier which is trained to discriminate between business documents comprising business images and personal documents comprising personal images, based on image content;
assigning a first printing protocol to a first document which is classified as a business document, the first printing protocol permitting printing of the first document on the color printer; and
assigning a second printing protocol to a second document which is classified as a personal document, the second printing protocol including at least one of monitoring and restricting printing of personal documents on the color printer; and
executing the assigned printing protocols.

21. The method of claim 20, wherein the execution of the second printing protocol includes at least one of the group consisting of:
blocking printing of the document;
redirecting the printing of the document to a printer different from a printer selected for the printing; and
storing information related to at least one of:
the document selected for printing,
the assigned document category, and
the identity of the user.
